(19) United States
(12) Patent Application Publication
(10) Pub. No.: US 2025/0287337 A1
(43) Pub. Date: Sep. 11, 2025

(54) Interaction between AI-based and Traditional Positioning Techniques

(71) Applicant: Apple Inc., Cupertino, CA (US)

(72) Inventors: Oghenekome OTERI, San Diego, CA (US); Dawei ZHANG, Saratoga, CA (US); Haitong SUN, Saratoga, CA (US); Hong HE, San Jose, CA (US); Huaning NIU, San Jose, CA (US); Wei ZENG, Saratoga, CA (US); Weidong YANG, San Diego, CA (US); Yushu ZHANG, Beijing (CN)

(21) Appl. No.: 18/858,574

(22) PCT Filed: Apr. 29, 2022
(86) PCT No.: PCT/CN2022/090585

§ 371 Date: Oct. 21, 2024

(51) Int. Cl. H04W 64/00; H04L 5/00; H04W 84/12

(52) U.S. Cl. CPC H04W 64/00; H04L 5/005; H04W 84/12

(57) ABSTRACT

A user equipment (UE) configured to determine the UE to be capable of performing a first positioning scheme, determine the UE to be capable of performing a second positioning scheme, select one of the first and second positioning schemes the UE is to use to perform a positioning operation and calculate a position of the UE using the one of the first and second positioning schemes.

### TECHNICAL FIELD

This application relates generally to wireless communication, and in particular relates to interaction between AI-based and traditional positioning techniques.

### BACKGROUND

5G New Radio (NR) has introduced many radio access network (RAN) and core network (CN) enhancements, as well as an enhanced security architecture. Artificial intelligence (AI) and/or machine learning (ML) processes, e.g., deep learning neural networks, may be used to augment operations for the air interface. The use cases for AI/ML for the air interface include channel state information (CSI) feedback enhancement (e.g., overhead reduction, improved accuracy, prediction); beam management (e.g., beam prediction in time, and/or spatial domain for overhead and latency reduction, beam selection accuracy improvement); and positioning accuracy enhancements for different scenarios including, e.g., those with heavy no-line-of-site (NLOS) conditions.

### SUMMARY

Some exemplary embodiments aspects are related to a processor of a user equipment (UE) configured to perform operations. The operations include determining the UE to be capable of performing a first positioning scheme, determining the UE to be capable of performing a second positioning scheme, selecting one of the first and second positioning schemes the UE is to use to perform a positioning operation and calculating a position of the UE using the one of the first and second positioning schemes.

Other exemplary embodiments are related to a user equipment (UE) having a transceiver configured to communicate with a network and a processor communicatively coupled to the transceiver and configured to perform operations. The operations include determining the UE to be capable of performing a first positioning scheme, determining the UE to be capable of performing a second positioning scheme, selecting one of the first and second positioning schemes the UE is to use to perform a positioning operation and calculating a position of the UE using the one of the first and second positioning schemes.

Still further exemplary embodiments are related to a processor of a user equipment (UE) configured to perform, operations. The operations include storing one or more trained models and performing an artificial intelligence (AI) based positioning method using the one or more trained models to determine a position of the UE.

Additional exemplary embodiments are related to a user equipment (UE) having a transceiver configured to communicate with a network and a processor communicatively coupled to the transceiver and configured to perform operations. The operations include storing one or more trained models and performing an artificial intelligence (AI) based positioning method using the one or more trained models to determine a position of the UE.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows a diagram illustrating the interaction between traditional positioning methods and AI-based positioning methods according to various exemplary embodiments.

FIG. 4a shows a diagram in which a doppler estimate informs a neural network (NN) update rate for an AI based positioning scheme according to various exemplary embodiments.

FIG. 4b shows a diagram in which the doppler estimate is used to select one NN of “n” trained NNs according to various exemplary embodiments.

FIG. 4c shows a diagram in which an AI model identifying line-of-site (LOS)/no-line-of-site (NLOS) conditions informs the execution of a traditional positioning technique according to various exemplary embodiments.

FIG. 4d shows a diagram in which a selector AI identifies LOS/NLOS parameters for a UE relative to positioning nodes and selects an AI-based positioning scheme or a traditional positioning scheme according to various exemplary embodiments.

FIG. 4e shows a diagram in which a selector AI identifies a scenario and selects a NN or a traditional positioning scheme according to various exemplary embodiments.

FIG. 4f shows a diagram in which an update rate AI is an input to a location update for the AI model according to various exemplary embodiments.

FIG. 4g shows a diagram in which a selector AI selects a number of next generation Node Bs (gNBs) as an input to the AI based positioning scheme according to various exemplary embodiments.

FIG. 5 shows a more generalized model where multiple estimator stages may be used to determine the location according to various exemplary embodiments.

FIG. 6 shows a diagram of a multi-input based convolutional NN (CNN) according to various exemplary embodiments.

### DETAILED DESCRIPTION

The exemplary embodiments may be further understood with reference to the following description and the related appended drawings, wherein like elements are provided with the same reference numerals. The exemplary embodiments describe manners in which traditional positioning schemes may interact with artificial intelligence (AI) and/or machine learning (ML) based positioning schemes in a wireless network. In addition, the exemplary embodiments also describe exemplary manners of selecting between traditional positioning schemes or AI based positioning schemes and using AI based positioning schemes to enhance traditional positioning schemes or using traditional positioning schemes to enhance AI based positioning schemes.

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network. Therefore, the UE as described herein is used to represent any electronic component that is capable of accessing a wireless network and performing AI-based positioning and/or traditional positioning schemes to locate the UE.

The exemplary aspects are described with regard to the network being a 5G New Radio (NR) network and a base station being a next generation Node B (gNB). However, the use of the 5G NR network and the gNB are provided for illustrative purposes. The exemplary aspects may apply to any type of network that utilizes similar functionalities. For example, some positioning methods as described herein can be RAT-independent.

The exemplary embodiments are further described with regard to artificial intelligence (AI) and/or machine learning (ML) based location estimation. Any number of different AI/ML models may be used, depending on UE and network implementation. For example, a deep learning neural network may be used. Further, the various types of models may use different types of channel response data for training the model, as well as different types/densities of RS for the inference phase of the position estimation. Thus, reference to any particular AI-based location estimation model is provided for illustrative purposes. The exemplary aspects may apply to any type of AI-based location estimation model that uses a training phase and an inference phase that can be executed at a UE and/or a core network element, e.g., a location management function (LMF).

The exemplary embodiments are further described with regard to a location management function (LMF) of the 5G core network (5GC) to support location determinations for a target UE. As will be described further below, in the exemplary aspects described herein, the LMF may perform operations to facilitate the AI-based estimation of a UE location including: performing either one or both of an inference phase and a training phase of a positioning NN for locating the target UE; configuring RAN nodes and/or the UE to transmit/receive reference signals (RS) for channel response acquisition; and receiving/transmitting location estimation and/or channel response estimation feedback to/from the target UE. It should be understood that the LMF is not required to be in the core network. For example, the LMF may reside on a separate server(s) that are connected to the 5GC or may reside within the 5G RAN.

In addition, throughout this description, base station (e.g., a gNB) may be referred to as a “serving cell.” A gNB that is acting as a serving cell is the cell to which a UE is currently connected, e.g., the UE may be in a Radio Resource Control (RRC) Connected state with the gNB and may be actively exchanging data and/or control information with the base station. A gNB may also be referred to as a “positioning gNB,” a “positioning node” or a “positioning cell.” A gNB acting as a positioning cell is a base station that is assisting in locating the UE, e.g., transmitting positioning reference signals (PRS) to the UE to assist in locating the UE. A gNB may simultaneously act as a serving cell and a positioning cell with respect to a UE or may act only as a positioning cell for a UE. Additionally, throughout this description a gNB may be referred to as a “neighbor cell” or “neighboring cell.” The neighboring cell, according to the present disclosure, may not act as a serving cell for the UE, however certain signals may be exchanged between the neighboring cell and the UE without entering the RRC Connected state. One or more neighboring cells may act as additional positioning gNBs to assist in locating the UE.

A serving cell or a neighbor cell acting as a positioning gNB may include one or more transmission and reception points (TRP), e.g., a first TRP and a second TRP. One or more of the TRPs located at a particular positioning gNB may be used in the exemplary positioning methods and may be referred to as a “positioning TRP.” Multiple positioning TRPs may be located at a single positioning gNB.

Furthermore, throughout this description, various positioning methods are generally described as traditional positioning schemes or AI based positioning schemes. These positioning methods may include downlink (DL)-based positioning, uplink (UL)-based positioning, or combined DL+UL-based positioning, including, without limitation: assisted global navigation satellite system (A-GNSS) (GPS); wireless local area network (WLAN); terrestrial beacon systems (TBS); downlink time difference of arrival (DL−TDOA); DL angle of departure (DL−AoD); and multi round trip time (multi-RTT). In some positioning methods, a positioning reference signal (PRS) is transmitted on the DL from each of multiple network nodes, i.e., positioning transmission and reception points (TRP), to the UE so that the DL arrival timings of the respective PRSs at the UE may be determined, and a location of the UE determined therefrom. Additionally, other types of reference signals may be used on the DL to locate the UE, including channel state information reference signals (CSI-RS) and/or synchronization signal blocks (SSB), e.g., demodulation RS (DMRS). Uplink (UL) reference signals may also be used to locate the UE, including sounding reference signals (SRS). Those skilled in the art will understand that these reference signals may also be used for other purposes in addition to locating the UE. Thus, the RS described herein are not limited to any specific type of reference signal.

In addition, throughout this description, it should be understood that the AI based positioning schemes may use the same inputs as the traditional positioning schemes, however, the inputs are put into a model (e.g., NN) which analyzes the inputs to output a position rather than strictly applying mathematical rules or equations as in the traditional positioning schemes. Moreover, those skilled in the art will understand that the channel(s) over which the reference signals are transmitted typically has a delay spread across time and, as such, may be modeled with multiple taps at different delays. Thus, when the term tap is used in reference to the various input(s), it should be understood that the tap is referring to this concept.

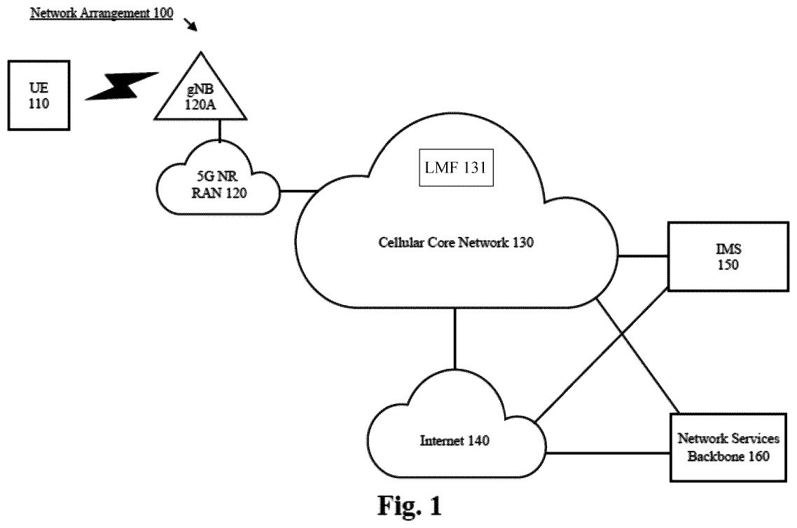

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary aspects, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. Reference to two gNBs 120A, 120B is merely for illustrative purposes. The exemplary aspects may apply to any appropriate number of gNBs.

In addition to the networks 120, 122 and 124 the network arrangement 100 also includes a cellular core network 130, the Internet 140, an IP Multimedia Subsystem (IMS) 150, and a network services backbone 160. The cellular core network 130, e.g., the 5GC for the 5G NR network, may be considered to be the interconnected set of components that manages the operation and traffic of the cellular network. The cellular core network 130 also manages the traffic that flows between the cellular network and the Internet 140. The core network 130 may include a location management function (LMF) 131 to support location determinations for a UE, as will be described further below.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

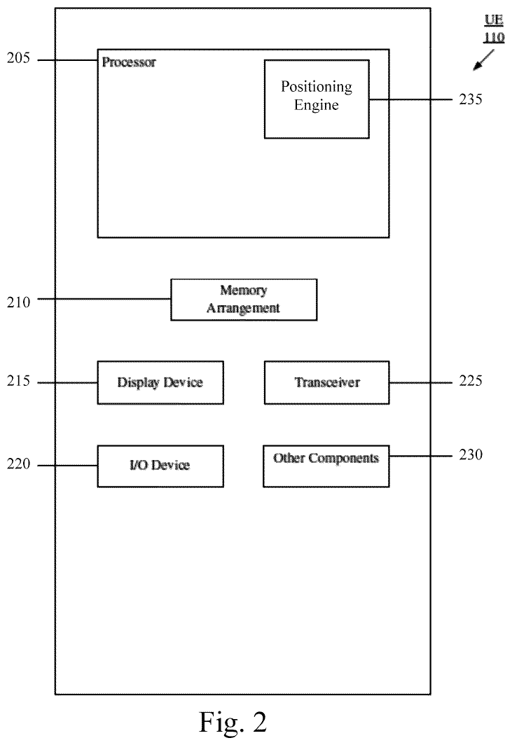

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. Additionally, the UE 110 may be configured to access an SNPN.

The processor 205 may be configured to execute a plurality of engines for the UE 110. For example, the engines may include a positioning engine 235 for performing operations related to positioning. Each of these operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary aspects may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

The exemplary network base station, in this case gNB 120A, may represent a serving cell for the UE 110. The gNB 120A may represent any access node of the 5G NR network through which the UE 110 may establish a connection and manage network operations. The gNB 120A may include a processor, a memory arrangement, an input/output (I/O) device, a transceiver, and other components. The other components may include, for example, an audio input device, an audio output device, a battery, a data acquisition device, ports to electrically connect the gNB 120A to other electronic devices, etc. The functionality associated with the processor of the gNB 120A may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor is split among a plurality of processors (e.g., a baseband processor, an applications processor, etc.). The exemplary aspects may be implemented in any of these or other configurations of a gNB.

The memory may be a hardware component configured to store data related to operations performed by the UEs 110, 112. The I/O device may be a hardware component or ports that enable a user to interact with the gNB 120A. The transceiver may be a hardware component configured to exchange data with the UE 110 and any other UE in the system 100. The transceiver may operate on a variety of different frequencies or channels (e.g., set of consecutive frequencies). Therefore, the transceiver may include one or more components (e.g., radios) to enable the data exchange with the various networks and UEs.

According to various exemplary embodiments, the interaction between traditional positioning methods and AI-based positioning methods is described. In previous NR releases, many traditional location techniques were proposed including RAT-dependent location techniques (e.g., time difference of arrival (TDOA), angle of arrival (AOA), etc.) and RAT-independent location techniques (e.g., global navigation satellite system (GNSS)). These traditional techniques may interact with AI-based positioning in a number of ways. The exemplary embodiments may define the interaction for the UE.

In one aspect of the interaction between traditional and AI-based positioning methods, the UE will not simultaneously perform a traditional positioning scheme and an AI-based positioning scheme. In one option, the UE does not expect to be configured with the two schemes simultaneously. In another option, the UE may be configured with the two schemes simultaneously, but may switch between the schemes semi-statically or dynamically. In this option, a new UE capability may be introduced to report whether the UE supports such concurrent configuration.

In another aspect of the interaction between traditional and AI-based positioning methods, the UE may be configured with both a traditional positioning technique and an AI-based positioning technique and may switch between the two in specific scenarios. For example, under certain circumstances such as high Doppler or non-line-of-sight (NLOS) scenarios, a UE may fall back to the traditional location scheme, and, outside these pre-defined scenarios, use the AI-based positioning scheme by default. In some exemplary embodiments, the LMF may semi-statically or dynamically configure a switch between the positioning scheme types when a scenario is detected that triggers the switch. In other exemplary embodiments, the UE may autonomously switch between location types when a scenario is detected that triggers the switch.

In still another aspect of the interaction between traditional and AI-based positioning methods, the traditional positioning services can be used to calibrate the AI-based positioning, and the AI-based positioning can be used to calibrate the traditional positioning. For example, a calibration location can be determined based on (a) any of the RAT-independent techniques (e.g., GNSS) or (b) RAT-dependent techniques (e.g., TDOA, AOA) defined in 3GPP Rel-16 and Rel-17. The calibration error can be used as an input into the AI model update rate decision. For example, if the calibration error is greater than a calibration error threshold for a time duration greater than a calibration time duration, then an AI model update can be requested.

In a further aspect of the interaction between traditional and AI-based positioning methods, NN inference input RS parameters (e.g., periodicity, density of RS) for the traditional location methods and/or the AI-based positioning methods can be modified based on AI based location services. In one example, the AI model may be able to predict that, based on current performance, reducing density or periodicity of the measurement signal and/or measurement feedback will fall within location tolerance requirements. In another example, the periodicity/density can be increased if error between the two methods exceeds a threshold. In still another example, PRS/P-SRS may be turned on/off. In still another example, the output of AI model can include accuracy or error estimates (in addition to position). This output can be used to determine the RS parameters (periodicity, density). The RS parameters may be semi-statically (RRC configured) or dynamically changed based on error estimate. In one scenario, the UE may request for multiple reports or inputs (position, NN input) for both AI based and traditional methods. Requests may be turned on/off for a specific method as needed. In some exemplary embodiments, there may be multiple predefined sets of RS having various characteristics (e.g., periodicity, density, etc.). The AI model may be used to select the specific one of the sets that should be used in the current UE environment.

In an additional aspect of the interaction between traditional and AI-based positioning methods, a hybrid AI-based and traditional positioning service may be used. In one example, the UE may detect a line of sight (LOS) or no line of sight (NLOS) condition between a gNB and the UE (or between each of multiple gNBs and the UE). For LOS links, a traditional positioning approach can be used to identify the distance (time of arrival, TOA) between the UE and the gNB, For the NLOS links, an AI-based positioning approach can be used to identify the distance (TOA) between the UE and the gNB.

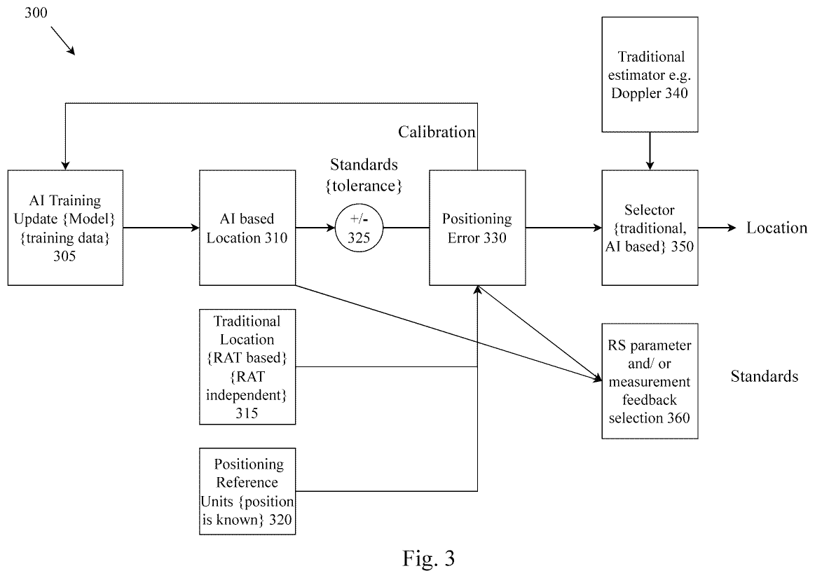

FIG. 3 shows a diagram 300 illustrating the interaction between traditional positioning methods and AI-based positioning methods according to various exemplary embodiments. Various aspects of this interaction, as shown in the exemplary aspects described above, are included in the diagram 300. However, it should be understood that various features shown in the diagram 300 can be used alone or in combination with other features shown in the diagram 300.

The box 305 shows the training of the AI model. The box 305 can represent the initial training of the AI model or a re-training of the model after a calibration phase, e.g., an AI training update.

The box 310 shows an inference phase of the AI model. The box 310 includes the AI-based location determination based on neural network (NN) inference input, e.g., channel response parameters for reference signals (RS). The RS may be uplink (UL) RS, e.g., positioning SRS (P-SRS), or downlink (UL) RS, e.g., PRS, having some periodicity and density.

The box 315 shows a traditional (RAT-based or RAT-independent) positioning determination and box 320 shows a position determination from a positioning reference unit (where the position is known).

The box 325 shows a comparison of the position determinations from the AI model, the traditional scheme, and/or the positioning reference unit to determine a positioning error in box 330 (e.g., the differences between the positions determined by the different positioning methods). This positioning error may then be used for various purposes.

For example, if the error exceeds a threshold, the AI model may be retrained (calibrated) in box 310, e.g., using different training data. As described above, there may also be a time duration associated with the error, e.g., the error exceeding the threshold for a predetermined period of time may trigger the retraining.

In another example, based on the positioning error and an input from a traditional estimator 340 such as a doppler estimator, a selector 350 of the UE may select the position method that should be used to output the position. For example, if the error exceeds a threshold and the doppler estimator indicates the UE is operating in a high doppler environment, the selector 350 may select the location determined by the traditional scheme.

In a further example, the positioning error may be used by the UE to indicate to the network the type of RS and/or measurement feedback selection that should be used for the location services as shown in the box 360. As shown in FIG. 3, this selection shown by the box 360 may be based on the positioning error or may also be base don the AI positioning output without considering the positioning error.

According to further aspects of the exemplary embodiments, the AI-based positioning may be executed using multiple inputs and/or types of input. AI-based location may be based on raw high density data such as Channel State Information (CSI), Channel Impulse Response (CIR), and/or location features such as layer 1 Reference Signal Receive Power (L1-RSRP), power delay profile, beam index, NLOS and Doppler. Interaction between these multiple inputs may influence the AI architecture in various ways.

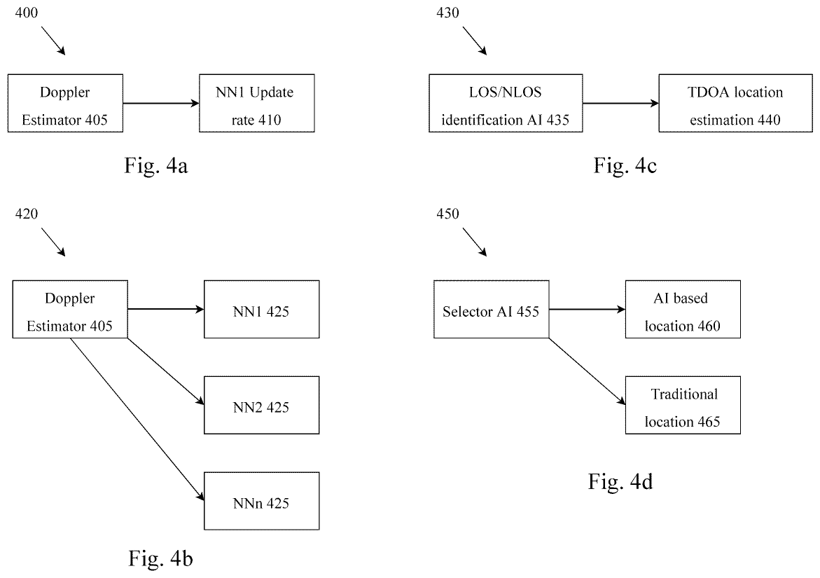

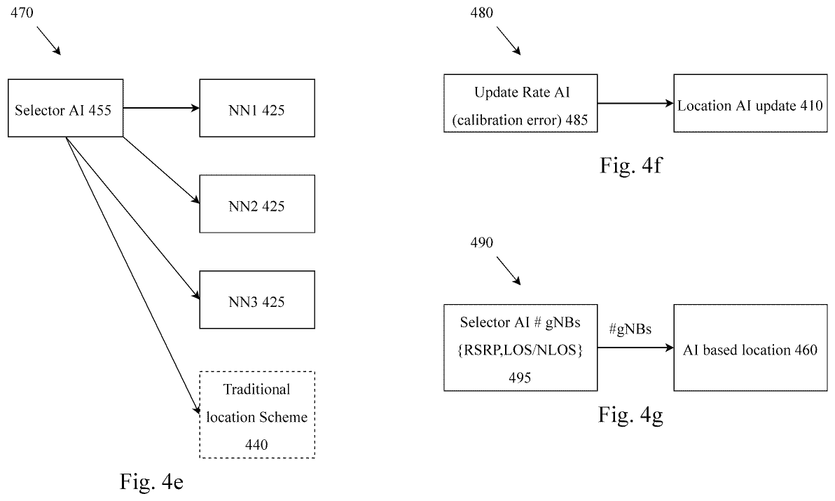

In one aspect of multi-input AI based positioning, traditional estimation techniques can inform the AI-based modeling. FIG. 4a shows a diagram 400 in which a doppler estimate 405 informs a neural network (NN) update rate 410 for an AI based positioning scheme according to various exemplary embodiments. Thus, in this example, a traditional velocity related technique (doppler) is used as an input to decide on how often the AI model (NN) should be updated.

In another example, the Doppler estimator may be used to select one NN out of multiple trained NNs. FIG. 4b shows a diagram 420 in which the doppler estimate 405 is used to select one NN 425 of “n” trained NNs 425 according to various exemplary embodiments. In this example, there are three (3) trained NNs 425. Each of the NNs 425 may be trained based on different scenarios for which the NN 425 is designed, e.g., mobility states such as stationary, slow moving, fast moving, etc. The doppler estimate 405 can be used to select the best NN 425 for a particular mobility scenario. For example, if the doppler estimate 405 indicates the UE is moving at a high rate of speed, the doppler estimate 405 may be used to select the NN 425 that was trained for high mobility scenarios. Again, in this example, a traditional velocity related technique (doppler) is used as an input to decide which NN should be used for positioning purposes.

In another aspect of multi-input AI-based positioning, the AI based modeling can inform the traditional estimation techniques. FIG. 4c shows a diagram 430 in which an AI model 435 identifying line-of-site (LOS)/no-line-of-site (NLOS) conditions informs the execution of a traditional positioning technique 440 according to various exemplary embodiments. In this example, the traditional positioning methods is a TDOA-based positioning method. However, this is only exemplary as other types of traditional positioning methods may also be supplemented with the AI information. As those skilled in the art will understand, TDOA is based on the UE receiving reference signals (RS) from multiple transmission and reception points (TRPs). The TRPs may be different base stations, different cells of the same base stations that are co-located, different cells of the same base stations that are separated geographically, etc. That is, the TRPs may be any device capable of transmitting the RS for the purposes of the positioning techniques described herein. The receipt of the RS for the purposes of TDOA (and other positioning techniques) is dependent on tight synchronization and LOS. By understanding the LOS/NLOS characteristics of the different TRPs with respect to the UE, the UE may (a) identify the correct TRP to use for TDOA estimation (b) correct for synchronization errors or (c) select the correct traditional positioning technique to use (e.g., use a different technique than TDOA). Thus, in this example, an AI model that outputs LOS/NLOS information is used as an input to improve a traditional positioning technique.

FIG. 4d shows a diagram 450 in which a selector AI 455 identifies LOS/NLOS parameters for a UE relative to positioning nodes (e.g., TRPs) and selects an AI-based positioning scheme or a traditional positioning scheme according to various exemplary embodiments. As described above, the positioning techniques may be dependent on the LOS/NLOS with respect to the various TRPs for which the UE will measure or send RSs. Thus, the AI model 455 that may be used to identify the specific LOS/NLOS scenario with respect to each TRP may be used as an input to make the basic selection of whether the UE should perform an AI-based positioning scheme 460 or a traditional positioning scheme 465.

In another aspect of multi-input AI-based positioning, multiple AI models may be chained together where the output of one AI model comprises the input of the other AI model. That is, each AI model may be trained using different type of information and a position output (or some other output) of a first one of the models may be used as an input to s second one of the models that was trained using different information. By using the multiple models, the UE may refine the determined positions.

FIG. 4e shows a diagram 470 in which a selector AI 455 identifies a scenario and selects a NN 425 or a traditional positioning scheme 440 according to various exemplary embodiments. It should be understood that while the NNs 425 have the same reference numeral as the NNs in FIG. 4b, this does not mean that they are required to be the same NNs. Similarly, the traditional positioning scheme 440 has the same reference number as TDOA positioning scheme 440 in FIG. 4c, this does not mean that the traditional positioning scheme 440 must be a TDOA technique. In this example, each NN 425 may be trained based on different scenarios such as mobility, LOS/NLOS, etc. The selector AI model 455 can be used to select the NN 425 based on the environment that the UE is experiencing or can even select the traditional positioning scheme 440 if none of the NNs 425 match the current scenario. In addition, as discussed above, the selector AI 455 may select more than one of the NNs 425 and/or traditional positioning scheme 440 such that the output of one of the techniques may be used as an input to another technique.

FIG. 4f shows a diagram 480 in which an update rate AI 485 is an input to a location update for the AI model 410 according to various exemplary embodiments. The update rate AI 485 may provide an estimate of the confidence of the position. For example, inputs to the update rate AI 485 may include the position determined by the AI model 410 and positions determined by one or more traditional positioning techniques or a positioning reference unit. Those skilled in the art will understand that a network owner (or other entity) may deploy a positioning reference unit at a known position for the purposes of positioning calibration. The update rate AI 485 may be trained using various techniques to understand the relationship between these various inputs. The update rate AI 485 may run the model to determine if the AI model 410 needs to be re-trained (updated) based on the confidence that the update rate AI 485 has with the position output of the AI model 485.

FIG. 4g shows a diagram 490 in which a selector AI 495 selects a number of next generation Node Bs (gNBs) as an input to the AI based positioning scheme 460 according to various exemplary embodiments. As described above, the gNBs may be base stations that transmit and/or receive RS for the purposes of the positioning schemes. The selector AI 495 may be used to select the number and/or type of gNBs that are used for the AI based positioning scheme 460. For example, selector AI 495 may identify the gNBs for input into the AI-based location model. Data from the specified gNBs is used as input into the AI based positioning scheme 460. This input may include channel impulse response (CIR) input that may be selected based on AI-based LOS/NLOS classification, candidates selected based on L1-RSRP values relative to an AI-generated threshold, candidates based on optimal number of gNBs for location accuracy, etc. The selector AI 495 may consider each of these factors and indicate to the AI based positioning scheme 460 which gNBs and which inputs to use to determine the position.

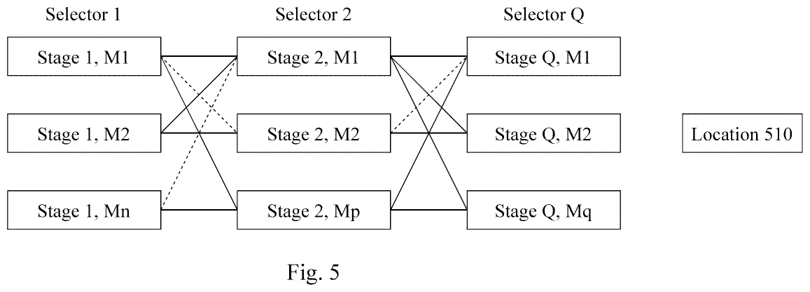

FIG. 5 shows a more generalized model 500 where multiple estimator stages may be used to determine the location according to various exemplary embodiments. Each stage may be made up of a mix of AI models or traditional estimators (e.g., doppler estimator 405, update rate AI 485, etc.) A selection of one stage may indicate a probability of selecting a next stage, e.g., NLOS implies an AI locator. The selectors may be local to each stage or global. The location method may implement these different stages in various manners as shown in FIG. 5 to result in the location output 510.

In an additional aspect of an AI based location with multiple inputs, multi-input based convolutional NN (CNN) may be used with different types (and amounts) of input into each branch. In a first example, it may be considered that CIR is more difficult to acquire with the required accuracy and has more overhead than L1-RSRP. Thus, for frequency range 2 (FR2), beam index may also be more accurate with low mobility and non-narrow beams. Therefore, the CNN may implement rules such as for N gNBs, when M<N gNBs use CIR, P≤N gNBs use a simpler metric (e. g., L1-RSRP) and Q≤N gNBs use beam index. In other examples, multi-input NN with different class of inputs may be used. In still further examples, the output of the AI model may include an accuracy measure or error estimate in addition to the position.

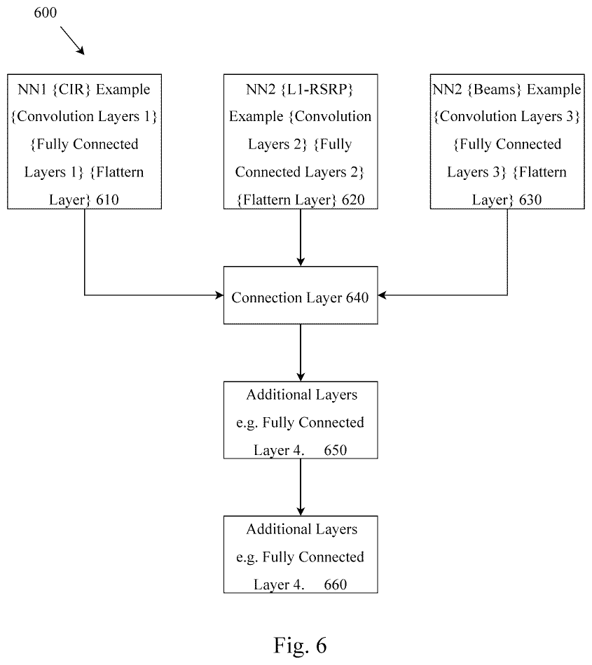

FIG. 6 shows a diagram 600 of a multi-input based convolutional NN (CNN) according to various exemplary embodiments. In this example, there are three (3) NNs, a CIR NN 610, a L1-RSRP NN 620 and a beam NN 630. These NNs 610-630 may include fully connected layers that are used as an input into a connection layer. As described above, the connection layer 640 may provide the location output based on the outputs of the three NNs 610-630. However, as shown in FIG. 6, there may be additional layers 650 and 660 that may be used to process the inputs to determine the output location.

The above has described various examples of traditional positioning schemes interacting with artificial intelligence (AI) and/or machine learning (ML) based positioning schemes in a wireless network. The following will provide some exemplary use cases and their impacts on the network.

As described above, in some exemplary embodiments, the UE may only implement one positioning scheme. In one example the UE may implement only an AI-based positioning scheme with the UE position as the output of AI model. In this example, the CIR and/or L1-RSRP may be inputs to the NN that results in the UE position output. Thus, in this example the UE may perform CIR estimation or L1-RSRP measurements on multiple gNBs and may also provide the corresponding feedback to the network (e.g., to the LMF).

In another example, the UE may implement both types of positioning where the AI-based positioning scheme does not output the UE position, but rather outputs information that may be useful to the traditional positioning scheme. For example, the output of the AI model may be a probability of whether a particular tap has a LOS or NLOS with the UE. This input may be used by the traditional positioning scheme (e.g., TDOA-based positioning) to determine which gNBs to use for the purposes of positioning. In another example, the output of the AI model may be a time of arrival (TOA) estimation for each off the gNBs. This may be used as a input into a TDOA-based positioning. In such an example, the UE may signal the TOA rather than the TDOA when performing the positioning, e.g., instead of signaling the LMF with TDOA information between two or more gNBs, the UE may signal the TOA.

As described above, the inputs to the AI model may include CIR, L1-RSRP, power delay profile (PDP), beam index, etc. These inputs may be generated from NN inference input acquisition procedures from multiple gNBs (e.g., any or all of the gNBs operating as positioning gNBs for the UE). These inference input acquisition procedures may include pre-processing, signaling, measurement and feedback related to the RSs and corresponding NN inference input.

In some exemplary embodiments, the AI may be used to optimize feedback of the CIR, PDP and L1-RSRP with the inference entity, e.g., LMF that may indicate a level of optimization. To provide some example, for the CIR, the optimized feedback may include the timing and magnitude of each tap. For the PDP, the optimized feedback may include the timing and magnitude of energy of each tap. For the L1-RSRP, the optimized feedback may include no timing and magnitude of all taps. Moreover, the feedback may be switched between types for different gNBs or there may be a modified PDP which includes timing of a set of taps and a sum of the magnitude of that set of taps.

### EXAMPLES

In a first example, a method performed by a user equipment (UE), comprising determining the UE to be capable of performing a first positioning scheme, determining the UE to be capable of performing a second positioning scheme, selecting one of the first and second positioning schemes the UE is to use to perform a positioning operation and calculating a position of the UE using the one of the first and second positioning schemes.

In a second example, the method of the first example, further comprising sending a capability message to a network indicating the UE supports the first and second positioning scheme.

In a third example, the method of the first example, wherein the first positioning scheme is one of a global navigation satellite system (GNSS) (GPS), a wireless local area network (WLAN) positioning method, a terrestrial beacon systems (TBS), a downlink time difference of arrival (DL-TDOA) positioning method, an uplink angle of departure (UL-AoD) positioning method, a DL angle of arrival (DL-AoA) positioning method or a multi round trip time (multi-RTT) positioning method.

In a fourth example, the method of the first example, wherein the second positioning scheme is an artificial intelligence (AI) based positioning method using one or more trained models.

In a fifth example, the method of the first example, wherein the determining one of the first and second positioning schemes is based on at least an environment in which the UE is operating.

In a sixth example, the method of the fifth example, wherein the environment includes a doppler shift the UE is experiencing or a non-line-of-sight (NLOS) to a base station.

In a seventh example, the method of the first example, further comprising receiving a message from a location and management function (LMF) of a network to which the UE is connected, wherein the determining one of the first and second positioning schemes is based on at least the message.

In an eighth example, the method of the first example, further comprising calibrating one of the first positioning scheme or the second positioning scheme using positioning data generated by the other one of the first positioning scheme or the second positioning scheme.

In a ninth example, the method of the first example, further comprising determining the position of the UE using the other one of the first and second positioning schemes, comparing the position determined by the first and second positioning schemes and performing a further operation based on the comparison of the position determined by the first and second positioning schemes.

In a tenth example, the method of the ninth example, wherein the further operation comprises updating an AI model for the one of the first and second positioning schemes when the comparison indicates a difference greater than a threshold between the position determined by the first and second positioning schemes for greater than a predetermined period of time.

In an eleventh example, the method of the ninth example, wherein the further operation comprises sending a message to a network indicating one of a reference signal (RS) parameter or a measurement feedback that should be used for the one of the first and second positioning schemes.

In a twelfth example, the method of the eleventh example, wherein the RS parameter comprises one of a periodicity or a density of RS signals used for the one of the first or second positioning schemes.

In a thirteenth example, the method of the eleventh example, wherein RS signals comprise one of positioning reference signals (PRS) or positioning sounding reference signals (P-SRS) and the RS parameter comprises turning the RS signals on or off or selecting one of a plurality of defined sets of RS signals.

In a fourteenth example, the method of the ninth example, wherein the operation comprises selecting the position determined by either the first or second positioning schemes based on at least an input from another estimator.

In a fifteenth example, the method of the first example, wherein the first and second positioning schemes comprise the UE receiving and measuring signals from one or more base stations and wherein the determining is performed for each of the one or more base stations and wherein the determining for each base station is based on at least whether the UE has a line-of-sight (LOS) or a non-line-of-sight (NLOS) to the base station.

In a sixteenth example, a processor of a user equipment (UE) configured to perform any of the operations of the first through fifteenth examples.

In a seventeenth example, a user equipment (UE) comprises a transceiver configured to communicate with a network and a processor communicatively coupled to the transceiver and configured to perform any of the operations of the first through fifteenth examples.

In an eighteenth example, a method performed by a user equipment (UE), comprising storing one or more trained models and performing an artificial intelligence (AI) based positioning method using the one or more trained models to determine a position of the UE.

In a nineteenth example, the method of the eighteenth example, further comprising determining a velocity of the UE based on a doppler estimation and determining whether to update the one or more trained models based on the velocity.

In a twentieth example, the method of the eighteenth example, further comprising determining a velocity of the UE based on a doppler estimation and selecting one of the one or more models to determine the position based on the velocity.

In a twenty first example, the method of the eighteenth example, wherein more than one trained model is used to determine the position, wherein an output of a first model is used as input to a second model.

In a twenty second example, the method of the eighteenth example, wherein one of the one or more trained models is used to determine the position, wherein the one of the trained models is based on at least an environment in which the UE is operating.

In a twenty third example, the method of the eighteenth example, wherein one of the one or more trained models is used to determine the position, wherein the one of the trained models is based on an input from the other one of the first and second positioning schemes.

In a twenty fourth example, the method of the eighteenth example, wherein the one of the first and second positioning schemes comprises the UE receiving and measuring signals from one or more base stations, wherein the one or more models are used to select a subset of the one or more base stations to perform the one of the first and second positioning schemes.

In a twenty fifth example, the method of the eighteenth example, wherein the one of the first and second positioning schemes comprises inputting one of a channel input response (CIR), a layer 1 Reference Signal Receive Power (L1-RSRP), or a beam index into the one or more models, wherein the one of the CIR, the L1-RSRP or the beam index is selected based on at least a number of base stations from which the UE is receiving reference signals (RS) when performing the one of the first and second positioning schemes.

In a twenty sixth example, the method of the eighteenth example, wherein the one of the first and second positioning schemes comprises a radio access technology (RAT) based positioning method comprising the UE receiving and measuring signals from one or more base stations and the other one of the first and second positioning schemes comprises an AI model estimating line-of-sight (LOS) or non-line-of-sight (NLOS) information for each of the base stations.

In a twenty seventh example, the method of the twenty sixth example, wherein the UE selects a subset of the one or more base stations for performing the RAT based positioning method based on at least the LOS or NLOS information for each of the base stations.

In a twenty eighth example, the method of the twenty sixth example, wherein the position determined by the one of the first and second positioning schemes is corrected for synchronization errors based on based on at least the LOS or NLOS information for each of the base stations.

In a twenty ninth example, the method of the twenty sixth example, wherein the RAT based positioning method comprises more than one positioning methods and the UE selects one of the RAT based positioning methods based on at least the LOS or NLOS information for each of the base stations.

In a thirtieth example, a processor of a user equipment (UE) configured to perform any of the operations of the eighteenth through twenty ninth examples.

In a thirty first example, a user equipment (UE) comprises a transceiver configured to communicate with a network and a processor communicatively coupled to the transceiver and configured to perform any of the operations of the eighteenth through twenty ninth examples.

Those skilled in the art will understand that the above-described exemplary embodiments may be implemented in any suitable software or hardware configuration or combination thereof. An exemplary hardware platform for implementing the exemplary embodiments may include, for example, an Intel x86based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
determining the UE to be capable of performing a first positioning scheme;
determining the UE to be capable of performing a second positioning scheme;
selecting one of the first and second positioning schemes the UE is to use to perform a positioning operation; and
calculating a position of the UE using the one of the first and second positioning schemes.

2. The processor of claim 1, wherein the operations further comprise:
sending a capability message to a network indicating the UE supports the first and second positioning scheme.

3. The processor of claim 1, wherein the first positioning scheme is one of a global navigation satellite system (GNSS) (GPS), a wireless local area network (WLAN) positioning method, a terrestrial beacon systems (TBS), a downlink time difference of arrival (DL-TDOA) positioning method, an uplink angle of departure (UL-AoD) positioning method, a DI angle of arrival (DL-AoA) positioning method or a multi round trip time (multi-RTT) positioning method.

4. The processor of claim 1, wherein the second positioning scheme is an artificial intelligence (AI) based positioning method using one or more trained models.

5. The processor of claim 1, wherein the determining one of the first and second positioning schemes is based on at least an environment in which the UE is operating.

6. The processor of claim 1, wherein the operations further comprise:
receiving a message from a location and management function (LMF) of a network to which the UE is connected, wherein the determining one of the first and second positioning schemes is based on at least the message.

7. The processor of claim 1, wherein the operations further comprise:
calibrating one of the first positioning scheme or the second positioning scheme using positioning data generated by the other one of the first positioning scheme or the second positioning scheme.

8. The processor of claim 1, wherein the operations further comprise:
determining the position of the UE using the other one of the first and second positioning schemes;
comparing the position determined by the first and second positioning schemes; and
performing a further operation based on the comparison of the position determined by the first and second positioning schemes.

9. The processor of claim 8, wherein the further operation comprises updating an AI model for the one of the first and second positioning schemes when the comparison indicates a difference greater than a threshold between the position determined by the first and second positioning schemes for greater than a predetermined period of time.

10. The processor of claim 8, wherein the further operation comprises (i) sending a message to a network indicating one of a reference signal (RS) parameter or a measurement feedback that should be used for the one of the first and second positioning schemes or (ii) selecting the position determined by either the first or second positioning schemes based on at least an input from another estimator.

11. The processor of claim 1, wherein the first and second positioning schemes comprise the UE receiving and measuring signals from one or more base stations and wherein the determining is performed for each of the one or more base stations and wherein the determining for each base station is based on at least whether the UE has a line-of-sight (LOS) or a non-line-of-sight (NLOS) to the base station.

12. A processor of a user equipment (UE) configured to perform, operations comprising:
storing one or more trained models; and
performing an artificial intelligence (AI) based positioning method using the one or more trained models to determine a position of the UE.

13. The processor of claim 12, wherein the operations further comprise:
determining a velocity of the UE based on a doppler estimation; and
determining whether to update the one or more trained models based on the velocity.

14. The processor of claim 12, wherein the operations further comprise:
determining a velocity of the UE based on a doppler estimation; and
selecting one of the one or more models to determine the position based on the velocity.

15. The processor of claim 12, wherein more than one trained model is used to determine the position, wherein an output of a first model is used as input to a second model.

16. The processor of claim 12, wherein one of the one or more trained models is used to determine the position, wherein the one of the trained models is based on at least an environment in which the UE is operating.

17. The processor of claim 12, wherein one of the one or more trained models is used to determine the position, wherein the one of the trained models is based on an input from the other one of the first and second positioning schemes.

18. The processor of claim 12, wherein the one of the first and second positioning schemes comprises the UE receiving and measuring signals from one or more base stations, wherein the one or more models are used to select a subset of the one or more base stations to perform the one of the first and second positioning schemes.

19. The processor of claim 12, wherein the one of the first and second positioning schemes comprises inputting one of a channel input response (CIR), a layer 1 Reference Signal Receive Power (L1-RSRP), or a beam index into the one or more models, wherein the one of the CIR, the L1-RSRP or the beam index is selected based on at least a number of base stations from which the UE is receiving reference signals (RS) when performing the one of the first and second positioning schemes.

20. The processor of claim 12, wherein the one of the first and second positioning schemes comprises a radio access technology (RAT) based positioning method comprising the UE receiving and measuring signals from one or more base stations and the other one of the first and second positioning schemes comprises an AI model estimating line-of-sight (LOS) or non-line-of-sight (NLOS) information for each of the base stations.
